(19) United States
(12) Patent Application Publication
(10) Pub. No.: US 2026/0050834 A1
(43) Pub. Date: Feb. 19, 2026

(54) Method for generating a dataset for training and/or testing a machine learning system

(71) Applicants: Julio Borges, Stuttgart (DE); Kevin Alexander Laube, Rottenburg Am Neckar (DE); Alexander Kugele, Kornwestheim (DE); Shin-I Cheng, Stuttgart (DE); Evgenia Youett, Wolfsburg (DE)

(72) Inventors: Julio Borges, Stuttgart (DE); Kevin Alexander Laube, Rottenburg Am Neckar (DE); Alexander Kugele, Kornwestheim (DE); Shin-I Cheng, Stuttgart (DE); Evgenia Youett, Wolfsburg (DE)

(73) Assignees: ROBERT BOSCH GmbH, Stuttgart (DE); CARIAD SE, Wolfsburg (DE)

(21) Appl. No.: 19/296,322

(22) Filed: Aug. 11, 2025

(30) Foreign Application Priority Data
Aug. 14, 2024 (EP) 24194564.1

(51) Int. Cl. G06N 20/00

(52) U.S. Cl. CPC G06N 20/00

(57) ABSTRACT

The invention relates to a method (100) for generating a data set (60) for training and/or testing a machine learning system (50), comprising:
providing (101) image data that are specific for depictions in which different environment scenarios are represented,
providing (102) metadata (65) that are specific for a description of the different environment scenarios,
creating (103) text prompts (70) based on the provided metadata (65), using information contained in the metadata (65) for the text prompts (70),
generating (104) the data set (60) based on the created text prompts (70) and preferably the provided image data.

### RELATED APPLICATIONS

This application claims the benefit of European Application EP24194564.1 (filed on Aug. 14, 2024), the entirety of which is incorporated by reference herein.

### FIELD OF THE INVENTION

The invention relates to a method for generating a data set for training and/or testing a machine learning system. The invention further relates to a machine learning model, a computer program, a device, and a memory medium for this purpose.

### BACKGROUND

It is known from the prior art that significant progress has been achieved in the generation of synthetic images, for example using generative text-to-image models such as Stable Diffusion. These models can generate images based on text input.

However, for many applications the generated images are too general and do not have sufficient versatility. This is frequently due to the fact that the text prompts on which the image synthesis is based are often very short, and contain inadequate descriptions of scenarios.

Furthermore, various other approaches in conjunction with image synthesis are known from the prior art, such as the use of Vision-Language Pretraining (VLP) systems.

Traditional approaches are also known from:
Rombach et al., High-Resolution Image Synthesis with Latent Diffusion Models (arXiv: 2112.10752), and
Li et al., BLIP-2, Bootstrapping Language-Image Pre-training with Frozen Image Encoders and Large Language Models (arXiv: 2301.12597).

### SUMMARY

The subject matter of the invention involves a method having the features of claim 1, a machine learning model having the features of claim 9, a computer program having the features of claim 10, a device having the features of claim 11, and a computer-readable memory medium having the features of claim 12. Further features and details of the invention result from the respective subclaims, the description, and the drawings. Features and details that are described in conjunction with the method according to the invention naturally also apply in conjunction with the machine learning model according to the invention, the computer program according to the invention, the device according to the invention, and the computer-readable memory medium according to the invention, and vice versa in each case, so that with regard to the disclosure of the invention, reciprocal reference is always possible.

The subject matter of the invention in particular involves a method for generating a data set for training, in particular also fine tuning, and/or testing a machine learning system, preferably the machine learning model according to the invention.

The machine learning system may include at least one machine learning model, preferably having at least one neural network, that can be tested and/or trained by the data set. The machine learning model to be trained and/or tested may be used for image classification, for example.

The machine learning system may also include a generative model that is designed to generate synthetic image data. In particular, the generative model is a generative text-to-image model such as Stable Diffusion.

The method may be used in conjunction with a vehicle control system. In particular, the method is used to generate data sets that are used for developing and/or enhancing vehicle control software. This may encompass machine learning, so that the generated data set for training and/or testing is used for the machine learning.

The method according to the invention may include provision of metadata, in particular digital metadata. The metadata may be specific for a description of different environment scenarios, in particular surroundings, preferably vehicle surroundings. The description may include, for example, information concerning a location and/or weather and/or driving conditions and/or the like. The metadata may be provided, among other ways, by retrieval from a data memory or a data interface. The environment scenarios may include, for example, arrangements of various objects and/or a roadway configuration and/or a three-dimensional structure of obstacles and/or roadway markings.

The metadata may be present in conjunction with image data with which they are associated. Therefore, the method according to the invention may also include provision of image data that are specific for depictions in which different environment scenarios are represented. This may be in each case, for example, a depiction of an environment, preferably vehicle surroundings, preferably during travel, for the different environment scenarios. The metadata are created, for example, during recording of the image data, for example automatedly and/or manually such as via driver input. The metadata may indicate, for example, a location and/or a time of the recording of the image data. In addition, the metadata may be automatedly and/or manually supplemented, for example by further information concerning the environment scenario in which the image data have been acquired/recorded. This may involve, for example, determining (such as by retrieval from a database) weather information that was present at the location of the recording at the time of recording.

In addition, the method according to the invention may include generation of text prompts based on the provided metadata. Information contained in the metadata (such as the weather information, for example) may be used for the text prompts, and in particular may be transformed into the text prompts and/or may adapt existing text prompts.

In the method according to the invention, generation of the data set based on the created text prompts and preferably also the provided image data may then be possible, the generation preferably being carried out by the machine learning system or some other generative machine learning system for data synthesis and in particular image synthesis. In other words, automated text generation for creation of prompts is possible, via which data sets having improved efficiency and/or quality and/or variance may be generated. The metadata are preferably directly used for the text generation to allow automated generation of detailed, diverse descriptions. The data set may be generated by a generative model, for example, preferably a generative text-to-image model such as Stable Diffusion, based on the created text prompts. The provided image data may optionally likewise be used as training data and/or test data or for training and/or testing, for example for further control of the images that are generated based on the text prompts.

The data set may be used, for example, for fine tuning and/or for training of a machine learning model via which image data are to be synthesized. It is also possible for the data set itself to already include the synthetic image data. The data set and/or the synthetic image data may be used, for example, for training a machine learning model that is used for autonomous driving of a vehicle and/or for situation interpretation and/or for perception during autonomous driving. The trained model thus finds application, for example, in AI-controlled visual recognition systems.

It may optionally be provided that the generated data set includes multiple training data for the training and/or testing of the machine learning system. The training data may be designed as image data, preferably synthetic image data. The generated data set or the training data may thus allow and/or be designed for provision of a representation, in particular of an environment, in the different and/or also newly generated environment scenarios. It is thus possible to generate diverse synthetic images that are subsequently used for the training and fine tuning of image models such as Stable Diffusion.

It is also conceivable for the training to be provided for training the machine learning system, using the generated data set, for classification, in particular image classification, of digital images based on image points and/or pixels, preferably edges or pixel attributes (of the images). These digital images may be, for example, digital images that result from a recording by at least one sensor, preferably at least one camera, preferably of a vehicle and particularly preferably of the camera surroundings and/or vehicle surroundings during travel (of a vehicle). The recording may be carried out, for example, by at least one camera of the vehicle. The classification may be provided for recognizing objects in an environment depicted by the digital images and/or for capturing a traffic scenario.

The classification may be provided for various technical applications. One example is the application in a vehicle. Based on the classification, in particular at least one classification result, for example at least one control action, preferably for a vehicle or for some other technical system, may be initiated and/or carried out.

A classification result may include at least one of the following results and/or may be specific for at least one of the following results: a category of objects, an identification of objects, a position of objects and/or obstacles (for example, in the travel direction or next to the travel direction), the presence of obstacles, a description of a traffic scenario, a hazard alert, the number of objects, a type and/or position of roadway markings and/or a roadway boundary, a position and/or a state of traffic signal installations, a position of a roadway, or the like.

Based on the classification result, at least one control action for the vehicle may be initiated and/or carried out. The control action may include at least one of the following: braking, steering, acceleration, passing, emergency braking, activation of an alarm system, activation of a hazard flasher, activation of a travel direction indicator, a light control system, or the like.

By use of the classification it is possible to recognize an obstacle, for example, regardless of whether it is situated directly in the travel direction or next to it. Depending on the location (for example, as a function of the probable vehicle trajectory), an appropriate control action such as deceleration or evasion may be initiated.

For example, braking may also be initiated when the classification indicates that obstacles are present in the travel direction and/or that a collision is likely. It is also conceivable for a roadway and/or a roadway boundary to be recognized based on the classification, in order to move the vehicle on the roadway at least semi-automatedly by means of the control action.

The vehicle may be designed as a motor vehicle and/or a passenger car and/or an at least semi-autonomous vehicle.

The method according to the invention may have the advantage that the training data and/or test data may be generated with a high level of variation, in particular for representing various environment scenarios. This may improve the reliability of the training and/or testing and of the resulting trained learning system for the classification task. The testing may take place within the scope of the training, for example, by dividing the generated data set into test data and training data and using the test data for checking the training progress. In particular, due to a high level of variation in the data set the generalization capability of the learning system may be improved, so that the classification may also be used in new situations, for example for controlling the vehicle.

The “classification” and “image classification” may also encompass “object detection” or “object detection in images.” This is understood in particular as a classification of whether or not objects are present in certain areas of the image. In addition, the terms “classification” and “image classification” may also refer to “semantic segmentation,” in particular in the form of pixel-by-pixel classification.

It is also optionally conceivable for the image data and/or metadata to result from sensor-based detection and preferably image capture of the surroundings of a vehicle and/or of a camera, and/or from detection by at least one sensor, in particular of a camera, preferably of the vehicle, in which the metadata for describing the environment scenario have preferably been defined. This yields the advantage that the method for creating text prompts may take into account a large number of various environment scenarios for the image synthesis. In addition, the method may be more reliable and accurate, since the descriptions are based on precise data concerning the surroundings. A more accurate text description for a synthetic image generation results in greater accuracy in the representation of realistic surroundings and objects in the generated image data.

It may also be possible for the machine learning system to include (at least) one generative model, preferably for generating synthetic images, and/or (at least) one machine learning model for use for at least semi-autonomous driving. The generated synthetic image material in the image data may then be used, for example, for the training data sets or test data sets of the machine learning model. This procedure minimizes the complexity and the costs for data acquisition, and at the same time increases the quality and quantity of the available data, thus greatly improving the training of the learning system. A further advantage is the flexibility in adjustment requirements for the training data.

It may be possible for the provision of the image data to also include: provision of the image data that result from sensor-based detection, and which have been supplemented by the metadata, preferably (manually) by a driver within the scope of trips in the particular environment scenario. It is thus possible for the image data to be enriched with additional information via the metadata. This supplementation may optionally also be based on data sources such as vehicle cameras or other sensors that perform recording of the image data during travel. Data sources for determining the metadata that are not used directly for the sensor-based detection, for example a cloud server for determining weather data, or a GPS system, may likewise be used. The driver may also provide the metadata or further metadata manually. A more comprehensive representation of the environment scenarios may be made possible by accessing these expanded data sources, which further improves the training and testing of the machine learning system. It also increases the accuracy and quality of the text prompts.

It may optionally be possible for the creation of the text prompts to include: transformation of the information contained in the metadata into a text prompt in each case in order to take into account, for the data set to be generated, preferably including multiple of the images to be generated, at least one of the following pieces of information from the metadata and to preferably represent same in the images:
environmental conditions, in particular weather or time of day,
context details of the surroundings or of the particular environment scenario, preferably the roadway type or traffic situation,
localization information, preferably from GPS detection.

This has the advantage that the created text prompts become even more detailed, and are thus also able to provide more context for the images to be generated.

Within the scope of the invention it may be provided that the creation of the text prompts also includes transformation of the metadata, in which the metadata are converted into structured text prompts. The metadata may be randomly selected for the transformation. Use of a probabilistic approach ensures a high level of diversity of the text prompts. This has the advantage that higher variance of the data set may likewise be achieved.

The generation of the data set may preferably take place using a generative machine learning model. Alternatively or additionally, it is conceivable that for generating the data set, the created text prompts are supplemented with a conditional spatial layout in order to take into account conditions for an application of the machine learning system, also in generation of the data set. Via the combination of created text prompts with a conditional spatial layout, it may thus be ensured that a realistic representation of the surroundings is generated. This allows improved, realistic generation of the data set. An edge recognition method may preferably be used.

The subject matter of the invention further relates to a machine learning model which results from a training using (at least) the following steps:
generating a data set using a method according to the invention,
training the machine learning model at least with the generated data set.

The machine learning model according to the invention thus provides the same advantages as described in detail with regard to a method according to the invention.

It is possible for the method according to the invention to be used for manufacturing an at least semi-autonomous driving system and/or a driver assistance system for a vehicle. The vehicle may be designed as a motor vehicle and/or passenger car and/or autonomous vehicle, for example. The vehicle may have a vehicle device, for example for providing an autonomous driving function and/or a driver assistance system. The vehicle device may be designed to at least semi-automatically control the vehicle, in particular to accelerate and/or decelerate and/or steer the vehicle. For this purpose, the control may take place based on an output of the machine learning system, preferably the machine learning model according to the invention.

The subject matter of the invention further relates to a computer program, in particular a computer program product, that includes commands which, when the computer program is executed by a computer, prompt the computer to carry out the method according to the invention. The computer program according to the invention thus provides the same advantages as described in detail with regard to a method according to the invention.

The subject matter of the invention further relates to a device for data processing that is configured to carry out the method according to the invention. For example, a computer that executes the computer program according to the invention may be provided as the device. The computer may have at least one processor for executing the computer program. In addition, a nonvolatile data memory may be provided in which the computer program is stored and from which the computer program may be read out by the processor for the execution.

The subject matter of the invention further relates to a computer-readable memory medium that includes the computer program according to the invention and/or commands which, when executed by a computer, prompt the computer to carry out the method according to the invention. The memory medium is designed, for example, as a data memory such as a hard disk and/or a nonvolatile memory and/or a memory card. The memory medium may be integrated into the computer, for example

In addition, the method according to the invention may also be carried out as a computer-implemented method. Alternatively or additionally, at least one of the disclosed method steps may be computer-implemented and/or carried out in an automated manner.

### BRIEF DESCRIPTION OF THE DRAWINGS

Further advantages, features, and particulars of the invention result from the following description, in which exemplary embodiments of the invention are described in detail with reference to the drawings. The features mentioned in the claims and in the description, in each case alone or in any given combination, may be essential to the invention. In the figures:

FIG. 1 shows a schematic visualization of a method, a device, a machine learning model, a memory medium, and a computer program according to exemplary embodiments of the invention.

FIG. 2 shows a schematic illustration for visualizing a method according to exemplary embodiments of the invention.

FIG. 3 shows a further schematic illustration for visualizing a method according to exemplary embodiments of the invention.

### DETAILED DESCRIPTION

A method 100, a device 10, a machine learning model 51, a memory medium 15, and a computer program 20 according to exemplary embodiments of the invention are schematically illustrated in FIG. 1.

The illustrated method 100 is used to generate a data set 60 for training and/or testing a machine learning system 50.

According to a first method step 101, image data are provided which are specific for depictions in which different environment scenarios are represented.

According to a second method step 102, metadata 65 are provided which are specific for a description of the different environment scenarios. The metadata 65 may include specific information concerning the surroundings that are depicted by recorded image data. In addition, the metadata 65 may include specific information concerning the conditions under which the recording has taken place. This involves in particular information, acquired during the recording, concerning the actual recording situation.

According to a third method step 103, text prompts 70 may then be created based on the provided metadata 65 in order to use information contained in the metadata 65 for the text prompts 70. If the metadata 65 indicate, for example, that snow or rain has occurred during the recording, this may be incorporated into the corresponding text prompt 70.

In addition, according to a fourth method step 104 it is possible to generate the data set 60 based on the created text prompts 70 and preferably the provided image data.

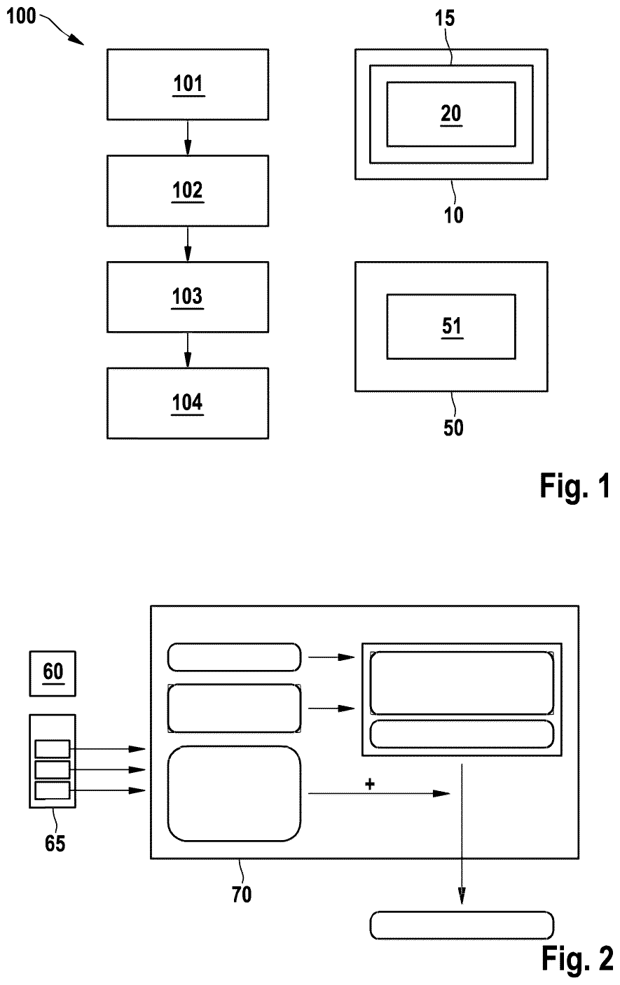

Furthermore, FIG. 2 shows a graphical description of embodiment variants of the invention. Within the scope of exemplary embodiments, use may be made of the synergy of models such as Stable Diffusion and ControlNet to create synthetic images that resemble those recorded using vehicle cameras.

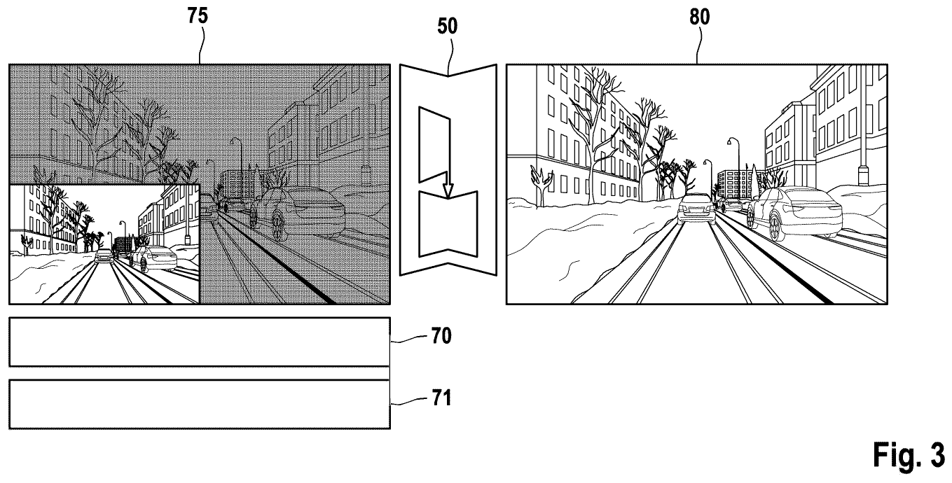

The synthetic images 80 may be generated in each case using the following primary inputs:
a conditional spatial layout that is structured primarily using edge recognition methods such as Canny (see FIG. 3, in which an edge map 75 is illustrated), and
a descriptive text prompt for defining all-encompassing image features, such as a snow-covered roadway and the like,
optionally, further input 71 such as random noise.

Optionally, the text prompts may be automatically created using automatic annotations such as BLIP (see the cited prior art literature). However, these annotations are generally very short and not detailed enough, resulting in poorer generation of images. Embodiment variants of the invention may thus make a contribution in this area by creating improved, detailed text descriptions. For this purpose, available metadata may be utilized for better (more diverse and accurate) image generation based on descriptive, detailed text prompts.

One problem with conventional approaches, which is addressed by embodiment variants of the invention, is the generation of synthetic images which often lack diversity and specificity due to the limitations of current text prompt methods. Traditional text-to-image models often generate images that are too general or do not have sufficient versatility to effectively train advanced AI perception models. In addition, the dependence on manual annotations for creating text descriptions is often too inefficient, and not scalable for large data sets.

Exemplary embodiments of the invention can at least partially solve these problems by providing a method 100, visualized in FIG. 1 by way of example, for creating text prompts and which utilizes the available metadata in recorded data sets. This approach ensures that the created text prompts are versatile as well as specific, which results in generation of synthetic images that are representative of actual scenarios and are versatile enough to train robust AI models.

Due to the use of detailed metadata, in addition the process of prompt creation can be automated, which increases the efficiency and reduces the dependence on manual efforts or automated methods that do not meet the criteria stated above. The problem of limited diversity and specificity of conventional methods as well as the inefficiency of manual annotation is at least partially solved by this approach for metadata-based prompt development.

Exemplary embodiments of the invention also provide an approach for prompt engineering that utilizes solely metadata that are linked to images. In other words, in the method, according to exemplary embodiments of the invention the provided metadata may be the sole data basis for generating the text prompts.

According to exemplary embodiments of the invention, the method also includes the extraction and conversion of metadata information (such as time of day, roadway type, and weather conditions) in structured text prompts. This method ensures that the text prompts are not only accurate, but also encompass a broad spectrum of image features, thus increasing the diversity and specificity of the generated images.

### I. Collection of Metadata

According to a first option, the metadata-based prompt engineering approach may utilize a comprehensive database containing metadata for the provision, which in such applications has been routinely compiled and updated with great care. This often takes place via manual inputs by drivers who have collected the data during trips under various environmental conditions. These metadata include a broad spectrum of information that may be relevant for the images, such as environmental conditions, geographical locations, time of day, and certain events or circumstances that have occurred during the data acquisition.

According to exemplary embodiments of the invention, the method 100 may extract the metadata in the provision step 101 illustrated in FIG. 1 in order to use them as the basis for the text prompts. The metadata may then be carefully analyzed to ensure their relevance and accuracy in the representation of the image context. If the metadata indicate, for example, that an image of a rainy evening in an outlying area has been recorded, according to the method 100 a text prompt may be created which accurately reflects these conditions. The process includes, for example, the categorization and prioritization of metadata elements in order to create a coherent, detailed description.

### II. Probabilistic Randomization

Probabilistic models may be additionally used to increase the diversity and avoid redundancy in the text prompts. These models may select various metadata elements according to the random principle and combine them to ensure that every prompt is as unique as possible and reflects a wide range of possible scenarios. This randomness is crucial for generating a plurality of image descriptions, which is advantageous for effective training and fine tuning of the generative models.

Due to the use of metadata that have been collected by the drivers, the described approach not only provides a high level of accuracy and relevance in the text prompts, but also contributes to the generation of a comprehensive, diverse data set. This data set is of great value for improving the capabilities of text-to-image models, and allows creation of more precise and diverse images that better reflect the complexity of actual scenarios.

This metadata-based prompt engineering approach provides several important advantages:
The accuracy of the text descriptions may be improved by the direct use of the metadata. The metadata may reflect the specific, factual information about the images.
The diversity of the text prompts may be significantly enhanced, since metadata often include a wide range of image features, from environmental conditions to context-related details.
The method may contribute to automation and streamlining of the process of creating detailed, diverse text descriptions for image data sets.

Possible applications of embodiment variants of the invention include improvement of the training and the fine tuning of text-to-image models such as Stable Diffusion. In addition, by providing a method for creating diverse, detailed text-to image pairs, it is possible not only to improve the quality and variability of the generated images, but also to provide a contribution to enhancement of data processing techniques and development of more sophisticated generative models.

In the above explanation of the embodiments, the present invention is described solely in terms of examples. Of course, individual features of the embodiments, if technically feasible, may be freely combined with one another without departing from the scope of the present invention.

1. A method for generating a data set for training and/or testing a machine learning system, comprising:
providing image data that are specific for depictions in which different environment scenarios are represented,
providing metadata that are specific for a description of the different environment scenarios,
creating text prompts based on the provided metadata, using information contained in the metadata for the text prompts,
generating the data set based on the created text prompts and preferably the provided image data.

2. The method according to claim 1,
characterized in that
the generated data set is a training data set that includes multiple synthetic image data for training the machine learning system in order to provide a representation of the different and/or newly generated environment scenarios for the training.

3. The method according to claim 2,
characterized in that
the training is provided for training the machine learning system, using the generated data set, for classification of digital images based on image points and/or pixels.

4. The method according to claim 1,
characterized in that
the metadata result from sensor-based detection, in which the metadata for describing the environment scenario have been defined.

5. The method according to claim 1,
characterized in that
the machine learning system includes a generative model and/or a machine learning model for use in at least semi-autonomous driving.

6. The method according to claim 1,
characterized in that
the provision of the image data also includes:
provision of the image data that result from sensor-based detection, and that have been supplemented by the metadata.

7. The method according to claim 1,
characterized in that
the creation of the text prompts also includes: transformation of the information contained in the metadata into a text prompt in each case in order to take into account, for the data set to be generated, at least one of the following pieces of information from the metadata:
environmental conditions,
context details of the particular environment scenario,
localization information.

8. The method according to claim 1,
characterized in that
the creation of the text prompts also includes transformation of the metadata, in which the metadata are converted into structured text prompts, wherein the metadata are randomly selected for the transformation.

9. The method according to claim 1,
characterized in that
for generating the data set, the created text prompts are supplemented with a conditional spatial layout in order to take into account conditions for an application of the machine learning system in generating the data set.

10. The method of claim 1 further comprising training a machine learning model with the data set.

11. (canceled)

12. A device for data processing comprising:
a processor; and
a non-transitory computer-readable memory medium storing a computer program that when executed by the processor causes the processor to:
provide image data that are specific for depictions in which different environment scenarios are represented;
provide metadata that are specific for a description of the different environment scenarios;
create text prompts based on the provided metadata, using information contained in the metadata for the text prompts; and
generate the data set based on the created text prompts.

13. A non-transitory computer-readable memory medium that storing a computer program, which when executed by a computer, prompt the computer to:
provide image data that are specific for depictions in which different environment scenarios are represented;
provide metadata that are specific for a description of the different environment scenarios;
create text prompts based on the provided metadata, using information contained in the metadata for the text prompts; and
generate the data set based on the created text prompts.

14. The method of claim 1 wherein the dataset is generated further based on the provided image data.

15. The method of claim 3 wherein at least one of: (a) the image points and/or pixels are from digital images that result from a recording of the surroundings of a vehicle during travel and/or by a camera; and/or (b) control of the vehicle is provided based on the classification.

16. The method of claim 4 wherein at least one of:
(a) the metadata results from image capture by at least one sensor of a vehicle; and/or
(b) the metadata results from image capture by a camera.

17. The method of claim 5 wherein the generative model is configured to generate synthetic images.

18. The method of claim 6 wherein the image data that resulted from sensor-based detection, and that have been supplemented by the metadata, results from operation of a vehicle by a driver within the scope of trips in the particular environment scenario.

19. The method of claim 7 wherein at least one of.
(a) the data set comprises multiple generated images;
(b) the pieces of information are represented in the multiple generated images;
(c) the environmental conditions comprise weather or time of day;
(d) the context details of the particular environment scenario include the roadway type or traffic situation; and/or
(e) the localization information is determined from GPS detection;

20. The method of claim 9 wherein the data set is generated using a generative machine learning model.
